(19) United States
(12) Patent Application Publication
(10) Pub. No.: US 2008/0117808 A1
(43) Pub. Date: May 22, 2008

(54) Automatic configuration of network elements based on service contract definitions

(76) Inventors: Mark Henrik Sandstrom, Calgary (CA); Chad Arron Smith, Edmonton (CA); Michael Geoffrey Kliza, Edmonton (CA)

Correspondence Address: FENWICK & WEST LLP, SILICON VALLEY CENTER, 801 CALIFORNIA STREET, MOUNTAIN VIEW, CA, 94041, US

(21) Appl. No.: 11/609,340

(22) Filed: Dec. 12, 2006

Related U.S. Application Data
(60) Provisional application No. 60/866,208, filed on Nov. 16, 2006.
(60) Provisional application No. 60/869,326, filed on Dec. 9, 2006.

(51) Int. Cl. G08C 15/00

(52) U.S. Cl. 370/229

(57) ABSTRACT

An integrated telecom network service management system (SMS) enables automatic configuration of network elements (NEs) of a given network service contact based on commercial contract parameters entered via a GUI by the SMS user. The GUI of the SMS allows contract entry based on discrete contract parameter selector menus, causing the electronic contract definition files to be of predefined format of parameters within predefined range of discrete values. Moreover, the NEs are configured via binary control files formed of a predefined array of NE control register values, which are automatically computed by the SMS software based on the associated contract definition file. The NEs automatically copy from the SMS to their local memories their respective binary control files, based on which the NEs are configured to operate according to their network service contract applications.

### CROSS REFERENCE TO RELATED APPLICATIONS

This application claims the benefit of U.S. Provisional Application No. 60/866,208, filed Nov. 16, 2006, entitled “Intelligent, Self-Operating Network Element,” referred to herein with the reference number [6], and U.S. Provisional Application No. 60/869,326, filed Dec. 9, 2006, entitled “Automatic Creation of Network Element Configuration Files,” referred to herein with the reference number [7], both of which are incorporated by reference in their entirety.

This application is also related to the following, each of which is incorporated by reference in its entirety: [1] U.S. application Ser. No. 10/170,260, filed Jun. 13, 2002, entitled “Input-Controllable Dynamic Cross-Connect”; [2] U.S. application Ser. No. 10/192,118, filed Jul. 11, 2002, entitled “Transparent, Look-Up-Free Packet Forwarding Method for Optimizing Global Network Throughput Based on Real-Time Route Status”; [3] U.S. application Ser. No. 10/382,729, filed Mar. 7, 2003, entitled “Byte-Timeslot-Synchronous, Dynamically Switched Multi-Source-Node Data Transport Bus System”; [4] U.S. application Ser. No. 11/245,974, filed Oct. 11, 2005, entitled “Automated, Transparent System for Remotely Configuring, Controlling and Monitoring Network Elements”; and [5] U.S. application Ser. No. 11/566,178, filed Dec. 1, 2006, entitled “Direct Binary File Transfer based Network Management System Free of Messaging, Commands and Data Format Conversions.”

### BACKGROUND

The invention pertains to the field of telecom service management systems, and in particular to automatic configuration of network elements based on service contract data entry.

Acronyms used in this specification are defined below:

CMS Contract Management Systems

EMS Element Management System

ERP Enterprise Resource Planning system

GUI Graphical User IF

HW Hardware

IF Interface

NE Network Element

NFS Network File System

NMS Network Management System

PC Personal Computer

SMS Service Management Systems

SW Software

XML Extensible Markup Language

Conventional telecom service management systems are limited mainly to computerization of service contract data entry and maintenance, while separate systems are needed for network and network element management. These systems are commonly vendor specific, e.g. a given SMS is supported by only one ERP suite if by any at all, a given NMS only works with a certain type of EMS, and a given EMS only functions for network equipment of a specific vendor or a particular type or model, and so on. Moreover, there is hardly any end-to-end integration of these software systems required for end-to-end network service management.

These factors create a need for innovation enabling an end-to-end integrated network service management system, one that would enable managing a telecom service contract from customer contract data entry through network element configuration per contract requirements based on a generic user interface for accessing the generic, commercial contract data irrespective of any vendor specific implementation details of the network technologies with which a given service contract is fulfilled.

### SUMMARY

A streamlined, end-to-end integrated telecom network service management system (SMS) enables managing telecom service contracts from customer contract data entry via a graphical user interface (GUI) through to the network element (NE) configuration per the contract definitions.

In one embodiment, the SMS enables automatic configuration of network elements (NEs) of a given network service contact based on commercial contract parameters entered via the GUI by a user of the SMS. The GUI of the SMS may allow contract entry based on discrete contract parameter selector menus, producing electronic contract definition files that comprise predefined set of contract definition parameters, each within their predefined, discrete range of supported values. In addition, the NEs are configured via binary control files formed of a predefined array structure of NE control register entries. Consequently, deterministic relationships exist for deriving the control register values for the NEs of a given contract based on the user-entered contract definitions. These relationships, i.e. a rule set for translating text-based contract definition files into the corresponding binary NE control files, are coded into computer software for automatic and error-free repeated execution, enabling automatic configuration of NEs of a given contract based on commercial contract data entry by the SMS user. The NEs automatically copy from the SMS to their local memories their respective binary NE control files and are thus configured and able to operate dynamically per their network contract applications, even with NE control files that remain static for the duration of the contract for which the NEs were deployed.

Embodiments of the invention thus provide a network service management system with a GUI-based means for entering commercial contract data electronically into a database, software programs for automatically translating the contract data to NE configuration files, and automatic network routines for transferring the NE configuration files to their respective NEs of the contract.

Embodiments of the invention also provide software-automated method for producing network element (NE) configuration files based on user-entered network service contract definition parameters. This method involves capturing contract definition data via a GUI into a contract management system database, translating the contract definition data into binary NE configuration files, and transferring the NE configuration files to their target NEs deployed to fulfill the network service contract.

Embodiments of the invention also incorporate a software algorithm that automatically creates binary NE control files using text-based, digital network contract data as input. The algorithm determines the number of NEs for the contract and a rule set for computing values for the target NE control registers based on the contract data input, assigns the values for the NE control registers for the NEs associated with the contract based on the rule set, and forms the binary NE control files for the NEs associated with the contract based on the values assigned for the NE control registers.

### BRIEF DESCRIPTION OF THE DRAWINGS

FIG. 1 presents an overview of an integrated telecom network service management system, in accordance with an embodiment of the invention.

FIG. 2 illustrates an automatic service management process, involving software called Translation Engine (TE) that produces NE configuration data based on service contract data, in accordance with an embodiment of the invention.

FIG. 3 is a flow chart for the TE algorithm, translating text-based service contract data entries into binary NE configuration files, in accordance with an embodiment of the invention.

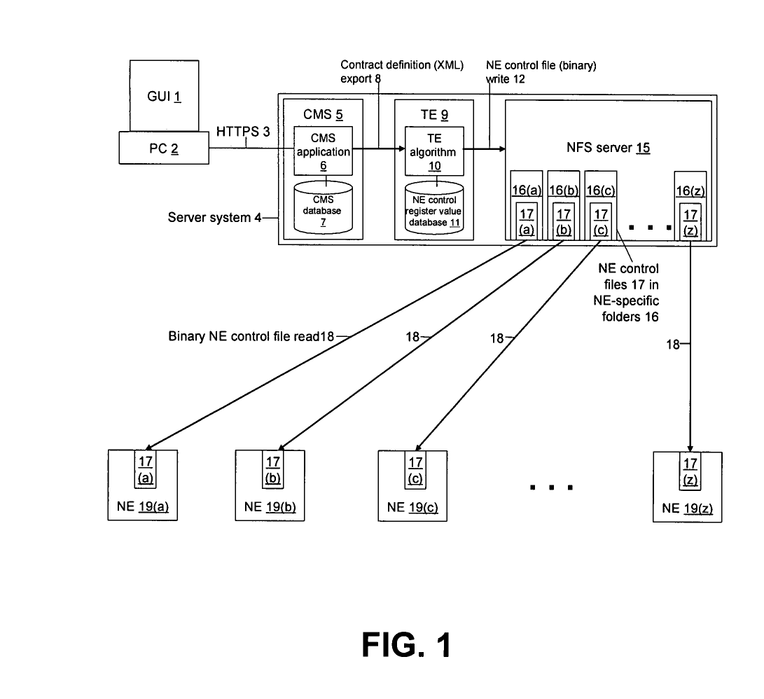

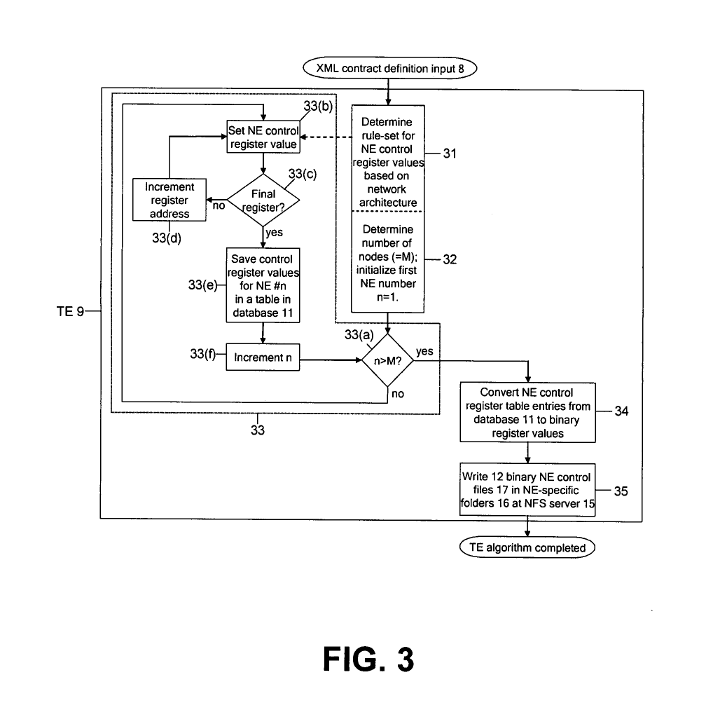

The following symbols and notations used in the drawings:
In FIG. 1 boxes connected with arrows and lines generally represent computing or communications devices, such as computers or network nodes.
A box drawn with a dotted line indicates that the set of objects inside such a box form an object of higher abstraction level, such as, in FIG. 3, an iterated process step 33 comprising its sub-steps 33(a) through 33(f).
Lines and arrows between nodes in the drawings represent a logical communication path, and may consist of one or more physical wireline or wireless connections. The direction of arrow does not preclude communication in also the opposite direction, as the directions of the arrows are drawn to indicate the primary direction of data flow with reference to the below description of the drawings.
Lines or arrows crossing in the drawings are decoupled unless otherwise marked.
Three dots between instances of an given object indicate an arbitrary number of instances of such an object, e.g. NEs 19 in FIG. 1, repeated between the drawn instances.

The figures depict various embodiments of the invention for purposes of illustration only. One skilled in the art will readily recognize from the following discussion that alternative embodiments of the structures and methods illustrated herein may be employed without departing from the principles described herein.

### DETAILED DESCRIPTION

FIG. 1 presents an overview of an integrated telecom service management system according to an embodiment of the invention. Herein, this integrated system is referred to as the Service Management System (SMS). As shown in FIG. 1, the SMS includes:
GUI 1 on a computer 2 for allowing a user of the SMS to access a component of the SMS referred to as Contract Management System (CMS) 5, to enter data to define network service contracts managed through the SMS, as well as to view contract data;
A server computer system 4, referred to as an Enterprise Resource Planning (ERP) server, that in one embodiment is used to host SMS component SW sub-systems, including the CMS 5, a Translation Engine (TE) 9 and a Network File System (NFS) 15;
CMS 5, which stores the user-entered network service contract definitions in a electronic, digital format, using SQL based database 7 in one embodiment, and exports 8 the contract definitions to the TE 9 in XML format;
Translation Engine (TE) 9, which automatically produces based on XML based contract definitions 8 NE configuration data as a set of binary Network Element (NE) configuration files 17 for a set of NEs, referred to as the target NEs 19 that are used for implementing a given network service contract;
Network File System (NFS) server 15, to where the binary NE control files 17 that the TE 9 created based on the XML contract definitions 8 are written 12 at NE specific folders 16, and from where the target NEs 19 copy their configuration files 17 into appropriate locations at their local memories, in one embodiment per the referenced applications [5] and [7]. Per FIG. 1, for each one of the set of NEs 19(a) through 19(z), there is a set of dedicated NFS directory 16 for holding the control file 17 for each given NE, e.g., the file 17(b) in the folder 16(b) for its target NE(b).

These elements of the SMS and their interactions are discussed in more detail below.

The CMS GUI 1 provides a discrete set of contract data entry options for each contract definition parameter for the user to select from a set of contract parameter selector menus. A practical way of implementing such GUI selectors with a discrete set of selectable options is using HTML pull-down menus. Examples of contract parameters to be selected by the user via GUI 1 include customer ID, the network architecture type, the number of NEs for the contract, the location code for each NE, access IF data rates and protocols for each NE, and network data rates for interconnecting the NEs. A possible contract definition thus entered via GUI 1 into the CMS database 7 thus could comprise a selection of the customer as customer #1234, network architecture defined for example as full-mesh between the NEs (selected from alternatives including point-to-point, hub-and-spoke, and full-mesh), specification of ten NEs (selectable between e.g. one to twenty NEs per a network), each with customer access IF type of MPLS over OC-192c (selected from e.g. either TDM or MPLS payload protocol structure, and from access rates of e.g. SONET OC-12, OC-48 and OC-192), and NE interconnection over 40 Gbps wavelength ring (selected from 2.5 Gbps, 10 Gbps and 40 Gbps wavelength rates). The referenced application [7] provides design specifications for a reference SMS implementation and for its GUI 1.

That the CMS GUI 1 is based on a discrete set of selectable values for the discrete set of contract definition parameters results in that the electronic contract definitions stored in the CMS database 7 are of predefined format and have a limited, instead of unlimited, range of possible values for each of the predefined set of contract definition parameters. Consequently, there is a discrete set of possible complete digital contract definitions, out of which a subset is such that the GUI 1 of the CMS application 5 of the SMS allows a user to enter into the SMS, based on what given contract implementation technologies, including the NEs 19, support. Moreover, the set of selectable contract parameter values at the CMS GUI 1 serves as an up-to-date, online record of the supported capabilities of the technologies used to fulfill the network service contracts, e.g. based on the set of network configuration applications so far tested successfully. This way, the CMS GUI 1 only allows a user to enter a contract such that is known to be technically implementable and supported by the technologies used for fulfilling the contracts, preventing possibility of invalid or non-supported contract entries.

In one embodiment, the TE 9 periodically checks for new XML-based contract definition files exported from the CMS 5. If a new CMS contract definition exists, the TE application reads in the XML contract definition file and runs its algorithm; otherwise, the TE application exits until its next scheduled execution.

That the XML contract definitions 8 are of predefined format and within a predefined range of values enables efficient conversion of such contract definitions into the binary NE configuration files 17 for the target NEs 19, by means of computer software. In one embodiment, e.g. based on principles of the referenced application [7] for MPLS and SDH/SONET network applications, the NE configuration files 17 are also of predefined format consisting of a discrete set of binary NE control register values, each with a set of supported values and predefined rules for deriving correct register values based on the contract definition parameters. Therefore, deterministic relationships exist for producing the NE configuration file 17 binary register values based on any given XML contract definition 8 created through the CMS GUI 1. Such deterministic rules are efficiently written in a form of a software program, to enable an error-free, repeatable execution of the XML to binary format conversion between the user-entered contract definitions and the corresponding network management configuration data for the NEs. In one embodiment of the invention, these deterministic rules are coded into the TE software algorithm 10 that converts text-based digital contract definitions into their corresponding binary NE control files 17. The referenced application [7] provides design specifications for a reference embodiment of SMS and the TE 9.

The server system 4 in one embodiment of the SMS also provides a secure NFS server 15 that stores the NE configuration files 17 at NE-specific directory locations 16. The NEs 19 provide NFS clients and copy their NE configuration files 17 from their respective directories 17 at the NFS server 15 to their local memories. The NEs, in SDH/SONET and MPLS based network applications utilizing principles of the referenced patent applications [1], [2], [3], [5], [6] and [7], are able to operate dynamically based on network data plane events according to the contract definition 8, based on these binary configuration files 17 even if these files 17 remain static throughout the duration of the contract.

A possible hardware implementation of the SMS is such that the computer 2 is a general purpose personal computer with an HTML browser displaying GUI 1 and supporting secure HTTP i.e. HTTPS connections 3 over internet with CMS application 6 on the ERP server 4. The ERP server can be implemented on a general purpose enterprise server computer, with e.g. Unix or Linux based operating system (OS). In one embodiment, the NFS is also hosted on a general purpose server computer, and the secure version of NFS used for transferring the NE configuration files 17 between NFS server 15 and the NEs 19 over internet is NFSv4.

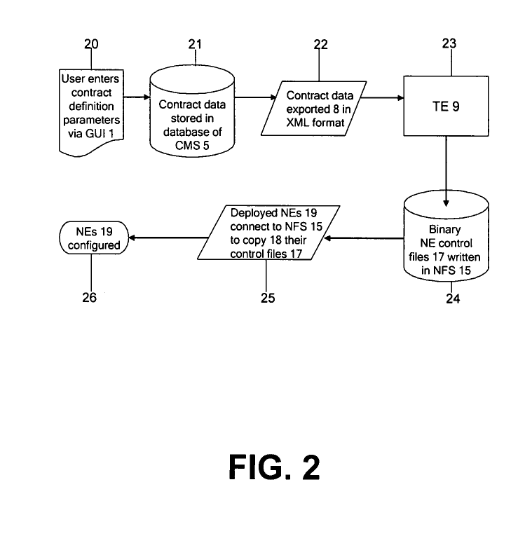

FIG. 2 presents a process diagram illustrating the integrated telecom network service management method, according to one embodiment of the invention. This method for forming NE configuration data i.e. binary NE control files 17 based on a network service contract definition entered via the SMS GUI 1 is herein referred to as the SMS process. The method includes process phases of:
Capturing network service contract definition data in CMS 5 entered by a user through a web based data entry interface (step 20 in FIG. 2);
Storing the contract definition data in the CMS database 7 in a digital format and exporting the contract definition in XML format from CMS 5 to TE 9 (steps 21 and 22 in FIG. 2);
Converting the contract definition data exported from the CMS database 7 automatically by a Translation Engine (TE) into binary configuration files 17 for a set of target NEs 19 used for implementation of the network service contract in question (step 23 in FIG. 2);
Transferring the NE configuration files to their target NEs (steps 24, 25 and 26 in FIG. 24).

These steps of the SMS process are discussed in more detail below.

In one embodiment, a user enters (step 20) contract definition parameters into the SMS via the CMS GUI 1, and the contract definition data is stored (step 21) by CMS 5 in its database 7, in one embodiment using SQL-based database.

As elaborated in the foregoing regarding FIG. 1, the contract data entry is based on a predefined, discrete set of contract parameters, each having a predefined, discrete set of supported i.e. selectable values, causing that the resulting XML contract definitions exported (step 22) from CMS 5 to TE 9 are also of predefined format and within a predefined, discrete range of values. Likewise, the NEs 19 are configured for their contract application based on NE configuration files 17 that comprise a predefined, discrete array of binary register values, e.g. per the referenced applications [6] and [7]. Hence, the conversion (step 23) of XML contract definitions 8 into binary NE configuration files 17 for target NEs 19 of the contract by the TE 9 is a task that is reduced to a translation between two discrete digital data sets, each of predefined format and predefined range of possible values. Such a task is efficiently implemented by a computer software program, i.e., the TE algorithm 10 in one embodiment. Engineering specifications for a TE algorithm 10 for one embodiment of the SMS process are included in the reference application [7].

In one embodiment, the TE 9, utilizing OS functions of the server 4, writes (step 24) the NE configuration data, i.e., the binary configuration files 17 for the NEs 19 associated with the contract in question at the NE specific directories 16 at the NFS server 15, from where the target NEs 19 of the contract copy (step 25) their new configuration files 17 over secure NFS to their local embedded memories, for instance according to the principles of the referenced application [5]. As discussed in reference to FIG. 1, in one embodiment the NEs e.g. per Appendix B of the referenced application [7], configured (step 26) for their contract application by their control files 17, operate dynamically in their network applications according to the contract definition even with NE configuration files 17 that remain static for the term of the contract, e.g., one to five years, as is common in the telecom industry.

FIG. 3 presents a data flow chart for the TE sub-system 9 of the SMS, according to an embodiment of the invention. Such TE automatically translates text-based, human readable service contract definitions 8 into binary NE configuration files 17. As shown in FIG. 3, the TE performs this translation (step 23 in the SMS process diagram of FIG. 2) as described below.

The TE periodically, e.g. once in 60 seconds, checks for a new contract definition in an NFS directory location to where CMS 6 application writes new XML contract definition files based on new contracts entered into the SMS by the user, and once found, the TE 9 reads in the new XML based contract definition file 8.

The TE algorithm 10 reads elements of the XML contract data input 8, including identification of network architecture selection made by the user via GUI, to determine (step 31) an appropriate rule set for deriving the control file register values for the target NEs 19 of the contract. An example of a rule set with which the NE control register values are set for the network contract, i.e., the NE control register programming notes, is provided with the referenced application [7] for MPLS and SDH/SONET network applications. In addition, the TE algorithm reads the other elements from XML contract data input, including the number (=M) of nodes i.e. NEs for the contract (step 32), and initializes the NE number to NE #1.

Once the NE number (n) has been initialized to #1 and until the NE number has reached the count of NEs in the contract i.e. #M, the TE algorithm iterates a loop 33 for creating NE-specific tables containing values of the NE control registers. This loop 33 begins with a step 33(a) of checking whether the current NE number (n) is already greater than to the count (M) of NEs in the contract, and if so, exit the loop and enter step 34, and otherwise continue in the loop 33 and move to its sub-loop of setting appropriate values for the NE-specific table elements representing the intended values of the NE control registers. In this sub-loop, each NE control register is here in step 33(b) assigned a proper value based on the rule set provided via step 31 and the number (n=1 . . . M) of the current NE, after which the current NE control register address i.e. table-entry index is checked in step 33(c) if it is equal to the count of control register address locations in the NE control file, e.g. 4096 addresses in one embodiment, and if so, the algorithm exists the sub-loop and moves to step 33(e), and otherwise increments in step 33(d) the address of the control register to be assigned a value in step 33(b). Once all control registers for the current NE have been assigned their proper values in that sub-loop, the table entries representing the values of NE control registers are saved in step 33(e) as that NE-specific table in the TE database 11, after which the NE number is incremented in step 33(f), and compared in step 33(a) again with the number of NEs in the contract, and so on.

Once the tables representing the intended values of their control registers in a text-based format have been completed by loop 33 for all the NEs of the contract, the TE algorithm converts in step 34 the entries of the NE-specific tables populated via step 33 into their corresponding binary NE control register values, thus forming the binary NE control files 17, which in one embodiment represent the binary NE control register values.

After producing the binary control files 17 for the NEs 19 of the contract, the TE writes 12 (step 35) the NE control files 17 into their appropriate NE-specific directories 16 at the NFS server 15, from where the NFS clients of the target NEs copy 18 their respective configuration files to the appropriate locations within their local memories, in one embodiment according to principles of the referenced applications [5], [6] and [7]. The TE algorithm is completed for the given contract once the TE has written its output binary NE control files 17 to the NFS 15.

The phrase “convert” in this specification generally refers to a process of producing a new representation output format from a given source or input data; it generally does not imply that the source or input data itself would become changed or eliminated in the conversion process. Instead, with the “conversion” processes, the input data is generally preserved while a new output data format is produced based on the input data.

Reference engineering specifications for one embodiment of the SMS are provided in the referenced provisional patent application [7]. Aspects of such a reference SMS implementation are recited in the following.

The GUI 1 allows a finite, technically feasible, range of contract definitions to be entered in the CMS 5, causing the rest of the SMS to be effectively implemented via full software automation. Moreover, in one embodiment, an XML based interface format, used for contract definition export 8 from CMS 5 to TE 9, provides a text-based means to describe and apply a tree-based structure to the contract data. Such XML interface allows decoupling the CMS and TE from a logical perspective; the CMS and TE thus do not need to be aware of each others' internal data formats and each can change internally independent of the other. The CMS application 6 produces the contract XML contract definition file for TE 9 through a series of SQL statements that retrieve the info relevant to the XML contract definition schema from its relational database 7. XML contract definition files may be generated this way one network contract at a time, initiated by the user via the GUI 1. The XML contract definition file is written 8 by CMS 5 to the NFS 15, from where the XML contract definition file is read into the TE 9 via an automatic routine that periodically checks for the presence of the XML contract definition file in the NFS, and if present, imports the XML contract definition into the TE application layer 10, to be used by the TE algorithm in its production of the binary control files 17 for the NEs 19 of the contract.

In one embodiment, the TE data layer 11 contains tables that represent the target NE control register memory spaces, e.g. per the referenced application [7] for MPLS and SDH/SONET based NEs, in which case these NE-specific tables will represent 4096 addressable byte memory locations via strings of 1's and 0's. After assigning proper values for these table entries for the target NEs of a given contract, e.g. per the NE control register descriptions and programming notes provided in Appendix B of the referenced application [7] for MPLS and SDH/SONET based contracts, the TE converts the table entries into binary bytes representing the intended values of their respective NE control registers, thus producing the target NE control files 17. After completing its algorithm, TE 9 writes these binary NE control files 17 in their respective NE-specific directories 16 at the NFS server 15, from where the NEs 19 of the contract copy 18 their respective control files to their local control register memory segments, and operate thereafter per their given network contract application.

The SMS of one embodiment functions according to an operating principle as described below.

A user of the SMS enters a network service contract data into the SMS via a GUI 1 of the CMS 5 component of the SMS. The data entry via the GUI is based on a discrete set of selectable options. The contract data is entered via the GUI in an order defined by the organization of the GUI, and earlier selections for data entry values can affect the selectable values for their related subsequent data entries. In one implementation, the GUI is web-based, i.e., such that can be used through an internet connected PC or workstation 2 using e.g. HTTP or HTTPS protocols for interaction 3 between the GUI 1 and the CMS 5.

The GUI based contract definition created from the discreet input space of selectable values is captured by the CMS 5 of the SMS in a database 7. In one embodiment, the CMS 5 resides at the UNIX/Linux based enterprise server system 4, and the CMS database 7 is MySQL based. The CMS application 6 exports 8 each new contract definition from its database 7 in XML format to the TE 9 sub-system of the SMS.

The TE automatically produces NE configuration data based on the user-entered contract definition data, by translating each new XML contract definition input 8 from CMS 5 into binary NE configuration files 17, based on which the NEs 19 deployed to fulfill the network contract are able to operate per their contract applications. The TE algorithm 10 stores the output binary NE configuration files 17 at their NE specific directories 16 at an NFS server 15, per the referenced application [5]. In one embodiment, the TE 9 and NFS 15 reside at the enterprise server computer 4, and a secured version of NFS, such as NFSv4, is used.

The NFS clients of the NEs 19 copy 18 their new binary configuration files 17 from their respective directories 16 at the NFS server 15 and store them on the appropriate memory locations within the NE embedded memories. The NEs function per the contract application based on these configuration files 17 they get from the NFS server.

According to the above described operating principle of the SMS, a possible practical implementation and usage scenario of one embodiment of such SMS is described below.

The user of SMS, e.g. network operator staff member, enters the contract definition parameters into the CMS 5 through the CMS presentation layer GUI 1. A finite set of valid contract definitions can be entered into the system. The contract entry is processed by the CMS application layer 6 and stored in the CMS data layer 7.

Elements of the contract definition are encapsulated into an XML file by the CMS application layer 6 using SQL calls to the CMS data layer 7. The CMS application writes 8, e.g. using PHP standard write( ) function, the contract definition via an XML file to the NFS 15 where it will be accessed by the TE 9.

TE application layer 10 is scheduled to execute in a periodic manner, e.g. once every ten seconds, for instance via a UNIX Crontab command. The referenced application [7] provides practical design specifications for the SMS software, including the TE algorithm. The TE algorithm translates the XML based contract definition into NE specific tables whose entries represent the intended values of the device control registers of each of the set of NEs 19 used for the fulfillment of the contract. At the end of the TE algorithm execution, the NE specific tables are converted to binary form, via the TE reading the text string 1's and 0's in the NE specific tables and writing the corresponding binary 1 or 0 into the binary NE control files 17, whose byte entries represent the intended binary contents of their target NE control registers. The TE writes 12 the NE binary control files 17 in their appropriate NE-specific directory locations 16 on the NFS 15.

The NEs 19 of the contract, once deployed, connect with the NFS 15 and copy 18 their corresponding NE binary control files 17 to their device control register memory segments, e.g. according to the principles of the referenced applications [5], [6] and [7], and thereafter operate in their contract applications based on network management control by these binary NE control files 17 providing the appropriate values for their device control registers.

The integrated and automatic SMS method is directly usable for implementing network service contracts with NEs based on the principles for self-operating network hardware per the referenced patent applications [1], [2], [3], [6] and [7], which are able to operate dynamically based on the network data plane events even with network management configuration i.e. NE configuration files that are static for the duration of a given customer network service contract. Note that while network data plane events, such that with prior art technologies would require changes to the network management configuration of NEs, can occur at sub-second intervals, the network service contract terms in telecom industry are often at last one year, requiring numerous network management configuration changes during a contract term when prior art techniques are used. Using an SMS as described herein thus avoids the need for such dynamic network management transactions, e.g. changes to the network management configuration of the NEs, during a contract term. The use of an SMS as presented herein thereby simplifies the network and service management processes and system implementations thereof, while improving the predictability, reliability and performance of the network and service management systems and processes. Engineering specifications for a reference implementation of an SMS are provided in the referenced patent application [7].

This specification describes various embodiments of the invention. Specific architectural and logic implementation examples are provided in this and the referenced patent applications for the purpose of illustrating practical implementations of the invented concepts. Naturally, there are several alternative ways to implement or utilize, in whole or in part, principles of the invention as set forth in the foregoing.

For instance, while the presentation of the SMS architecture subject matter of the present patent application, overview of which is shown in FIG. 1, is reduced to illustrating the organization its basic elements, it shall be understood that various implementations of that architecture can, for instance, have any number of NEs, NFS servers, ERP servers, GUIs, etc. Also, in different embodiments of the invention, the sequence of software and hardware and logic processes involved with the SMS process can be changed from the specific sequence described, the process steps could be combined with others and further divided into sub-steps. Furthermore, the elements and process steps associated with the SMS, e.g. PC and server computers, SW sub-systems, NEs, process phases and algorithm steps etc., described in this specification for clarity as separate elements or steps can in different embodiments of the invention be combined with other elements, steps etc. or be further divided into additional sub-systems or sub-steps etc., without departing from the principles of the invention. It is also obvious to those skilled in implementing embedded systems how certain system elements, functions or methods that in the embodiments described in the foregoing as being implemented by hardware, could in an alternative implementation of the principles of the invention be performed by software, or vice versa.

Therefore, those skilled in the art will be able to develop different versions and various modifications of the described embodiments, which, although not necessarily each explicitly described herein, utilize the principles of the invention, and are thus included within its spirit and scope. It is thus intended that the specification and examples be considered not in a restrictive sense, but as exemplary only, with the scope of the invention being indicated by the following claims.

What is claimed is:

1. A network service management system comprising:
means for entering contract data electronically to a database;
means for automatically translating the contract data to one or more network element (NE) configuration files; and
means for automatically transferring the NE configuration files to their respective NEs associated with the contract.

2. The system of claim 1, wherein the means for entering contract data electronically to a database includes a graphical user interface of a computer software program.

3. The system of claim 2, wherein the graphical user interface is configured to allow entry of contract data via selector menus from discrete sets of selectable contract data entry parameter values.

4. The system of claim 3, wherein the discrete sets of selectable contract data entry parameter values are supported by the network service management system and the NEs associated with the contract.

5. The system of claim 1, wherein the means for automatically translating the contract data to NE configuration files comprises computer software.

6. The system of claim 1, wherein the contract data is in a text-based electronic format.

7. The system of claim 1, wherein the NE configuration files comprise binary files representing intended control register contents for their corresponding NEs.

8. The system of claim 1, wherein the NEs are configured to operate dynamically according to corresponding network contract applications with NE configuration files that are static for the duration of the contract.

9. A method for forming network element (NE) configuration data based on network service contract definition data, the method comprising:
capturing in a database contract definition data entered via a data entry interface, the contract definition data describing a network service contract;
generating a set of NE configuration files for a corresponding set of NEs associated with the network service contract, the NE configuration files generated automatically based on the contract definition data; and
transferring the NE configuration files to the corresponding NEs.

10. The method of claim 9, wherein the contract definition data comprises:
a value indicating the number of NEs within the set of NEs associated with the network service contract, and
a set of definitions for NE customer access interfaces.

11. The method of claim 9, wherein the data entry interface is a graphical user interface of a computer software program.

12. The method of claim 11, wherein the graphical user interface provides a discrete set of selectable options for the contract definition data being entered.

13. The method of claim 9 wherein the NE configuration files are generated using computer software.

14. The method of claim 9, wherein the contract definition data is captured in the database in a text-based digital format.

15. The method of claim 9, wherein the NE configuration files each comprise a binary file representing intended contents of a control register for a corresponding NE.

16. The method of claim 9, wherein the NEs operate automatically according to corresponding network contract applications with NE configuration files that are static for the duration of the contract.

17. A method for automatically creating network element (NE) configuration data based on a network contract data input, the method comprising:
reading the network contract data input;
determining, based on the network contract data input, a number of NEs for a given contract and a rule set for assigning values for a set of NE control registers;
assigning values for the set of NE control registers for the NEs associated with the contract based at least in part on the rule set; and
forming NE configuration data comprising binary NE control files based on the values assigned for the NE control registers.

18. The method of claim 17, wherein the network contract data input is in a digital, text-based format.

19. The method of claim 17, wherein the binary NE control files represent intended contents of control registers for their corresponding NEs.

20. The method of claim 17, wherein the NE configuration data comprise exactly one NE control file for each one of the NEs associated with the contract.
